(19) United States
(12) Patent Application Publication
(10) Pub. No.: US 2003/0037444 A1
(43) Pub. Date: Feb. 27, 2003

(54) Ergonomically shaped, fixed blade, front loading utility knife with extra blades storage compartment having single blade retrieval system

(76) Inventor: Steve Howard Chunn, Maluern (AR)

Correspondence Address: Steve Howard Chunn, 189 River Oaks Rd., Malvern, AR, 72104, US

(21) Appl. No.: 09/852,765

(22) Filed: Aug. 21, 2001

(51) Int. Cl. B26B 5/00

(52) U.S. Cl. 30/337; 30/124

(57) ABSTRACT

A top accessible, pivotably mounted spring assisted blade locking mechanism provides a system permitting front loading capability through an opening in the front of the knife handle and a spare blades compartment accessible through a pivotably mounted side cover along with the employment of a pivotably mounted top accessible single blade retrieval system eliminates the need to separate the two mated halves of the knife handle to effect quick and safe blade change and maintenance of the spare blades supply. The importance of ergonomics is accentuated by the strategic integration of a smooth comfortably held shape with practical access of the required functions operating mechanisms.

### DESCRIPTION OF DRAWINGS

FIG. 1 is a view of the entire length of the knife as seen from the side. In this drawing the right end is the front of the knife and includes the position of the cutting blade. The left end of the drawing is the rear of the knife and the top edge is the top of the knife. The bottom of the drawing is the bottom of the knife and shows the shape of the bottom formed in such a way as to accommodate the fingers of the hand holding the knife, in a comfortable and secure manner.

FIG. 2 is a top view of the length of the knife showing the orientation of the top lid of the blade storage compartment, the cutting blade locking bar and the cutting blade in position at the front of the knife.

FIG. 3 from the interrupted vertical line at the right of the drawing going left to the end of the drawing is a side view of the rear half of the knife with the spare blades compartment side lid shown in its open position. Revealed is the spare blades compartment and the spare blades push plate.

FIG. 4 from the interrupted vertical line on the right to the end of the drawing at the left is a side view of the rear half of the knife with the top lid of the spare blades compartment in its open position. As shown by the drawing, the act of opening this top lid retrieves a single blade from the supply of spare blades in the spare blades compartment. Also shown is the side lid of the spare blades compartment with its small crescent shaped indentation in its upper right hand corner to facilitate its opening action.

FIG. 5 from the interrupted vertical line at the right of the drawing to the left of the drawing shows the top view of the back half of the knife with the top lid of the spare blades compartment in its open position. From this view there can also be seen the edge of the spare blade retrieved by the lid and the spring clips which are gripping the spare blade making possible its extraction from the spare blades compartment. In the spare blades compartment there can be seen the edge of the next available blade for retrieval by the top lid.

FIG. 6 from the interrupted line at the right of the drawing looking left is a top view of the rear half of the knife with the spare blades compartment top lid and side lid in their open positions. Also is a cutaway view revealing an interior view of the spare blades compartment and its relative parts. There can be seen the coil spring between the back sidewall and the spare blades push plate, the supply of spare blades and the interior construction of the housing which confines the blades to their storage area. Also there can be seen the hinge portion of the top lid and side lid and the accompanying small flat dual purpose spring assigned to each lid to hold the lids in their open and closed positions.

FIG. 7 is a top view of the length of the knife including the cutting blade with a view of the top lid. The top lid has a lip down the length of its two sides and across its front end which is indicated by the dotted line. This lip is mated to fit the notched edge of the area of the top of the knife covering the spare blades storage compartment when the top lid is in its closed position. The cutaway view of the front portion of the knife shows the cutting blade locking bar, the small coil spring located under the rear of the locking bar and a small portion of the top edge of the cutting blade chamber liner.

FIG. 8 is another side view of the knife which shows a cutaway view of the entire length of the knife to allow a view of the spare blades compartment with its top lid in the closed position to illustrate the grabbing action of the spring clips which are located on the underneath side of the lid and which are in this view locked onto a spare blade. Also shown is the hinged portion of the lid at the rear of the knife and the relationship of the flat spring which in its present position is holding the lid in its closed position by its action on the hinge portion of the lid. Also revealed by the cutaway view is the locking bar, the accompanying coil spring located beneath the rear of the locking bar, the pivot point of the locking bar with the pivot pin and the downward protrusion of the front of the locking bar which is mated to the notch in the blade chamber liner and either of the notches in the cutting blade. The cutting blade is in position in the blade chamber liner with the locking bar holding the blade securely from falling out. The tension for this action is provided by the coil spring under the rear of the locking bar.

FIG. 9 shows looking from the front of the knife a vertical cross section view intersecting the area of the cutting blade chamber and the chamber liner at the point the locking bar downward protrusion fits into the aligned notches of the blade chamber liner and the blade.

FIG. 10 shows looking from the front of the knife a vertical cross section view of the spare blades compartment intersecting at a line consistent with including a view of the top lid, and its orientation to the notched edges provided in the top of the side lid and top of that area of the knife which covers the spare blades compartment, a view of one of the spring clips in its grabbing position on a spare blade, a supply of spare blades, the spare blade push plate and the coil spring which pushes the plate against the blades to keep them firmly and uniformly pressed against the sidewall at the left of this drawing.

### GENERAL DESCRIPTION OF INVENTION

This invention has been developed to provide the professional tradesman and the occasional hobbyist and casual craftsperson with a fixed blade utility knife whereas the usual time consuming and cumbersome method of changing cutting blades which generally requires separating the two halves of the utility knife has been replaced by a much simpler and efficient method which does not require taking the utility knife apart. Installing a blade in this newly developed utility knife can be done merely by inserting the blade in the slot provided at the front of the knife and in the incidence of having to replace the blade after it has become dulled or broken through use, the blade can easily be removed from the front of the knife and the replacement blade is easily and safely retrieved from the spare blades storage compartment by the simple act of flipping open a lid. The combination of these features makes this invention unique in appearance and function and superior in its efficiency to all other utility knives found available on the market today. Along with the ergonomic consideration in the shape of the knife to provide a more comfortable grip and ease of use these features of this invention should provide a whole new dimension to the use and handling of the utility knife.

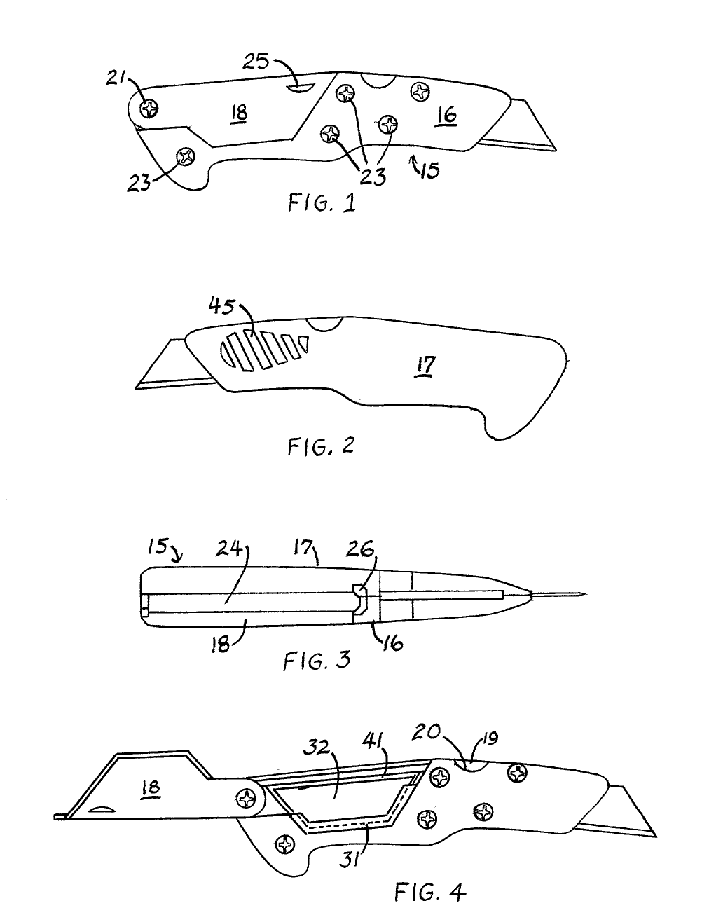

Although the mechanisms of this invention can be effectively installed in any shape utility knife handle, the inventor has shown in the drawings the preferred shape. The profile of which, 5, is best seen in FIG. 1 of the accompanying drawings. The invention as depicted in FIG. 1 has a part of the rear half of the body a side lid, 8, with the rear portion of the lid attached by hinged feature by means of a hinge pin, 7, these features further detailed in a subsequent part of the text of this description. In the upper right hand corner of the side lid, 8, there can be seen a small crescent shaped indention, 29, to accommodate the thumbnail for the purpose of opening the lid. An upward and backward motion of the front of the lid displaces it to its open position. The purpose of the lid is to allow exposure of the spare blades compartment thereby providing easy access to loading the spare blades compartment with a supply of spare blades. The inventor has intended for this compartment to hold a maximum of 5 extra blades.

Also seen in FIG. 1 just in front of the side lid at the top of the knife is an indention, 9, large enough to accommodate the tip of a thumb. Also seen in this area of the indention is a small portion of the locking bar, 10, which is part of the mechanism which locks the cutting blade, 6, in place for use. The complete details of this mechanism will be discussed in subsequent passages.

In FIG. 2 there is a view of the top lid, 12, of the spare blades compartment. It, too, has a hinged portion, 19, at the rear of the knife and the hinged portion, 11, of the side lid, 8, of FIG. 1 and the hinged portion of the top lid, 12, pivot on the same axis, open in the same direction, and share a common hinge pin. At the right end of the top lid there can be seen a depression, 16, in the top of the knife which allows the user to insert a fingernail under the end of the top lid and lift it upward and backward to its open position. The function of the top lid will be explained later in the text. In FIG. 2 there can also be seen the top view of the locking bar, 10, along with the top view of the thumb indention, 9. A pivot pin located in the body of the locking bar, indicated by the numeral, 26, in FIG. 1, permits the front portion of the locking bar to be raised enough to unlock the cutting blade, 6, for removal. This is effected by pressing downward on the rear of the locking bar, 10, with the tip of the thumb. The necessary clearance for this action is provided by the indention, 9, in the top of the knife. After the cutting blade has been removed the locking bar can be released from the pressure of the thumb and the locking bar will be returned to its original position by the action of a coil spring, 25, located under the locking bar in the area depressed by the thumb. As the bar is depressed, the coil spring is compressed and the release of the locking bar by the thumb allows the spring to decompress, raising the locking bar back to its original position.

Addressing the rear half of the knife and some of the incorporated features is the drawing depicted in FIG. 3. This view shows the side lid in its open position revealing a portion of the spare blades compartment, 35. From this view there can be seen the shape and orientation of the spare blades push plate, 13. This push plate acts to provide a consistent, equally distributed lateral pressure against the spare blades once they are loaded into the spare blades compartment. This pressure by the push plate is effected by means of a tapered coil spring placed between the push plate and the rear compartment wall. Details of this spring will be discussed later in the text.

An indention of the side opening, 36, of the spare blades compartment has the dual purpose of, one, providing a ledge upon which the side lid can rest in its closed position and, two, provides a perimeter wall for the spare blades to rest against as they are firmly held in place by the spring activated push plate. When the side lid is opened, the top lid is removed from its position simultaneously thus allowing the spare blades to be loaded by means of placing them inverted, sharp edge up position, against the push plate then pushing inward and downward to cause the blade to be placed in its appropriate position in the spare blades compartment so the bottom portion of the inverted blade and a portion of the angled areas of the two ends of the blade are retained behind the perimeter wall of the opening to the spare blade compartment. This orientation of the spare blades can also be seen in FIG. 8 numeral, 36, and FIG. 10, numeral, 36.

Although the top lid, 12, of the spare blades compartment is carried to the open position by the action of the opening of the side lid, the top lid can be opened independently of the side lid as is shown in FIG. 4 numeral, 12. In this side view depiction there can be seen the spare blade which has been retrieved by the action of opening the top lid. Numeral, 17, shows the lip which exists at the end of the lid and extends down the length of either side of the lid. Numeral 14, is the thicker, narrower part of the lid to which two spring clips are attached permanently. These spring clips are comprised of a “U” configuration with a straight tang on one side of the “U” and an angled tang on the other whereas the angled one has a bend in it where it touches the straight tang then angles slightly outward to produce a tiny “V” like opening. This “V” like opening is forced open and down each side of a waiting spare blade when the top lid is closed thereby clipping onto the blade. When the top lid is opened the gripping action of the spring clips extracts a blade, 18, from the spare blades supply. A detail of the spring clip can be seen on FIG. 10 numeral 15.

From the top view of the knife with the top lid, 12, in its open position there can be seen the lip, 17, on the underside of the perimeter of the lid and the outline of the center part of the lid, 14, to which the bladegripping spring clips, 15, are attached. From this view there can bee seen the way the two spring clips, 15, are spread to grip the spare blade, 18. A strategically placed flat leaf spring 30 against the specially shaped hinge portion holds the lid in its open position. This same spring also acts to hold the lid secure in its closed position. A similar spring is also employed to gain the same effect with the side lid. The orientation of this spring can also be seen and its counter part can be seen in FIG. 6, FIG. 8 and FIG. 11.

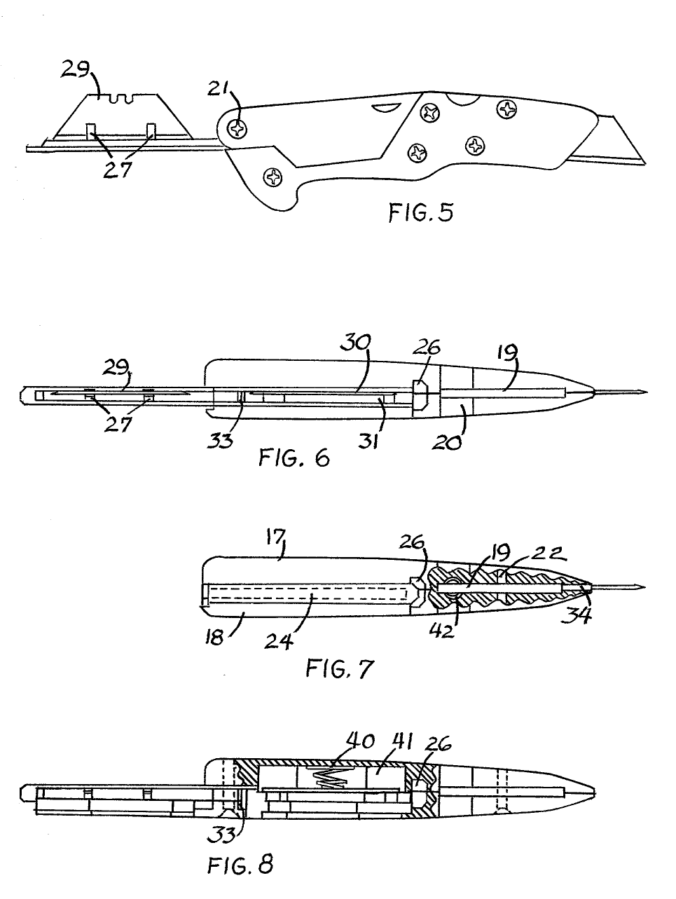

Also there can be seen in FIG. 5 the opening in the spare blades compartment created when the top lid is opened. The lid, 17, on the top lid rests on the ledges 23, 24, provided in the opening down each side of the opening. This ledge and the lip around the top lid are mated to encourage an accurate fit. The fit of the top lid in its closed position can also be seen in FIG. 10, numerals 12, 14, 23, 24. Inside the opening of the spare blades compartment there can be seen the next blade, 22, available for extraction.

In FIG. 6 the top lid, 12, and side lid, 8, of the spare blades compartment, 35, are in the open position to reveal the hinged portion of the lids, 19, and each lid's corresponding relative flat spring to hold each lid in its open or closed position. Also a cut away view of the top portion of the knife shows the structure of the spare blades storage compartment which includes the tapered coil spring which is located between the rear compartment housing and the spare blades push plate, 13. The push plate is being pressed against the supply of spare blades, 22, which are retained by the perimeter retaining wall, 36.

In FIG. 7 the top lid, 12, of the knife can be seen in its closed position along with the top view of the top edge of the side lid, 8, and the dotted lines show the manner in which the top lid fits onto the ledges in the top of the knife and the top edge of the side lid. The cut away view of the front half of the knife gives an internal top view of the blade locking bar, 10, the coil spring, 25, under the rear edge of the locking bar, the pivot pin, 26, of the locking bar and a small portion of the blade chamber liner, 27, and the cutting blade, 6, shown in place for use.

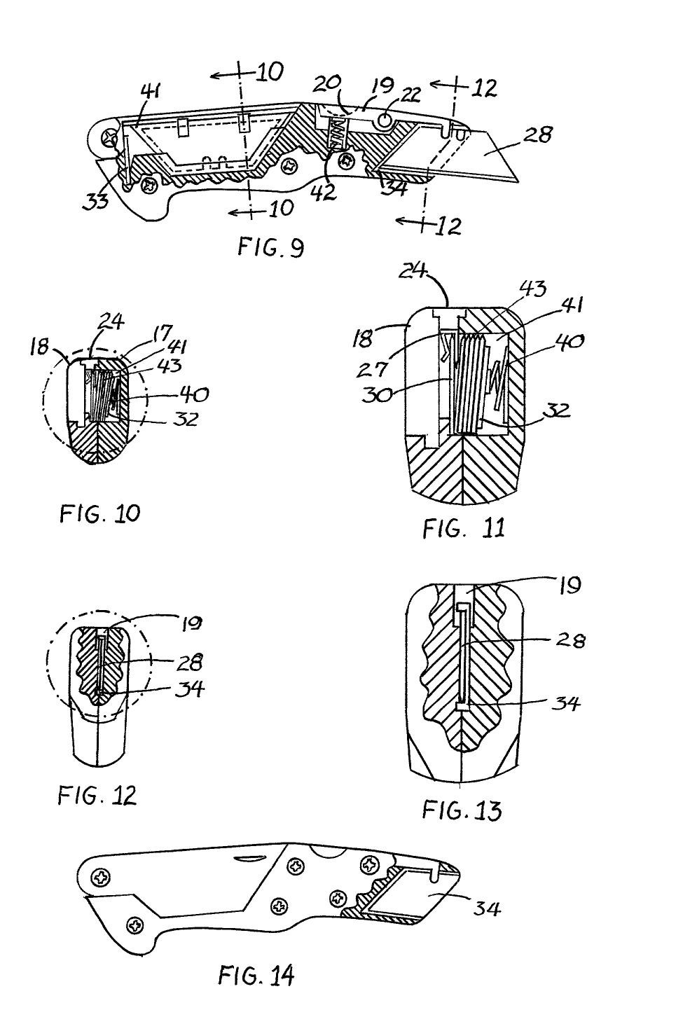

The mechanism of the cutting blade locking bar and the understanding of its use is best illustrated by the cut away side view presented in FIG. 8. The locking bar, 10, is shown in its locking position. It stays in this position until its movement is activated by pressing downward on the area of the locking bar indicated by the numeral, 10. This downward pressure by the tip of the thumb compresses the coil spring, 25, located directly beneath the area of the locking bar indicated by the numeral, 32. The pivot pin, 26, causes this downward pressure to raise the front portion of the locking bar disengaging the downward protrusion of the bar, 33, from the notch, 34, in the top of the blade chamber liner, 34, and one of the corresponding notches in the cutting blade, 6. Once the bar has been thusly disengaged, the cutting blade can be easily and safely removed by grasping the blade and pulling it out of the blade chamber, 27. The cut away also shows the rear half of the knife revealing the top lid in its closed position and its grip by the spring clip, 15, on a blade, 18, in the storage compartment. The vertical cross hatching contrasted against the 45 degree angle cross hatching depicts the retaining wall of the spare blades compartment. This retaining wall provides a surface for the spare blade to rest against as it is pushed over by the push plate. Also for view is the flat leaf spring, 30, which is installed against the specially shaped hinge portion of the lids to keep them open or closed. Also shown are the two spring clips, 15, gripping the spare blade, 18. The outline of the spare blade shows the portion which is resting against the retaining wall, 36. Looking from the front of the knife a cross section of the knife intersecting the blade chamber in the area of the downward protrusion of the locking bar there can be seen in FIG. 9 a view giving an illustration of the locking bar, 10, in place, the opening, 28, for the cutting blade and the cutting blade chamber liner, 27. The cutting blade chamber liner is a channel of hard material, probably steel would be best suited for this, which keeps the blade secure, preventing vertical movement, and to keep the blade from enlarging the blade chamber from pressure created through constant use.

In FIG. 10 looking from the front of the knife a cross section of the knife intersecting the spare blades compartment in the area of the tapered coil spring, 21, shows how the coil spring is exerting pressure on the push plate, 13, which applies a evenly distributed constant pressure on the spare blades, 22, to keep them pushed against the retaining wall, 36, around the opening to the spare blades compartment. The blade immediately against the retaining wall is the next available blade to be extracted by the action of opening the top lid. A cross section of the top lid can also be seen with the configuration of the spring clips, 15, attached to its underside and the manner in which the clip is gripping the spare blade.

The spare blades are stored in an inverted or upside down position with the sharp edge pointed in an upward direction. The blades are stored in this manner because the beveled sharpened edges of the blades in a side by side order creates a small “V” between each sharp edge. This “V” configuration allows the straight tang of the spring clips to penetrate between the blades to reach its necessary position to grip the blade. Once the blade has been extracted from the compartment by the opening action of the lid it is accessible to the user in its upright position allowing safe and easy removal from the clips to be then inserted into the slot provided for the cutting blade. Also seen in FIG. 10, are the ledges provided for the lip on either side of the top lid. Ledge 23, is formed on the top portion of the knife covering the spare blades compartment and ledge, 24, is formed on the top lid, 12, to assure an accurate fit and to provide a stop for the top lid in its closed position.

This knife has been specifically designed to employ the standard utility knife blade, and while the regular duty utility knife blade may be used in the knife, the inventor recommends the heavy duty blade be used. This type blade is universally standard and is used in most utility knives which are in use today. The shape and notch orientation of this type blade is illustrated on the drawing sheets in FIG. 4, numeral 18, in FIG. 8, numeral 18, and numeral 6, and FIG. 10, numeral 6. As is shown the blade has a trapezoid shape with the long edge or base of the trapezoid being the sharpened edge and the short edge or top edge having two notches, the orientation of which is equal in distance from either end which allows the blade to be disengaged from the knife if it has been dulled or the sharp tip has been broken and turned around and inserted back into the knife securely having a fresh sharp edge and tip ready for use.

Having disclosed the details of my invention, what I claim is:

1. A front loading, fixed blade utility knife comprising cooperating elements to provide;
a. housing for two complimentary first and second mating members to form a utility knife handle with said knife handle providing housing for a frontal internal axial cavity with said cavity exiting through the front end of said knife handle thereby providing an opening thereat with said frontal internal cavity comprising an integral element providing a side wall with a perpendicular flange providing peripheral walls at the top and bottom of said cavity and at an oblique angle at the rear of said cavity with said integral element permanently fixed on the interior surface of the front portion of said first handle member with said integral element cooperating with a flat surface provided on the interior surface of the of the front portion of said second handle member corresponding with said side wall of said integral element to form said internal cavity for the purpose of holding a substantial portion of a cutting blade slidably received therein through said front opening into said internal cavity thereby limiting the rearward travel of said cutting blade and limiting vertical and lateral movement of said blade,
b. latching means for retention of said cutting blade in a fixed position within said frontal internal cavity with said latching means comprising an elongated integral element and a spring element whereby said latching element is pivotably supported horizontally disposed at the top of the front portion of said knife handle with said latching element provided at its forward end a downward extended tab mated to a notch provided in the top margin edge of said cutting blade with said tab engaging said notch through an aperture provided in the top of said frontal internal cavity with said aperture aligned with said blade notch when said cutting blade is installed to the limit of its rearward travel within said frontal internal cavity with said spring element providing means to engage and hold said latching element in a blade retaining position thereby limiting forward travel of said cutting blade with operable means provided to disengage said spring assisted latching element from said notch to permit removal of said cutting blade,
c. housing for a spare blades storage compartment disposed within the rear portion of said knife handle providing storage for a plurality of spare blades in an inverted position with said compartment being housed adjacent to and corresponding with a cut away portion of said knife handle to provide an access opening to one side of said spare blades storage compartment,
d. means provided for enclosing said access opening to said spare blades storage compartment in the form of a side cover plate in conjunction with a top cover plate with said cover plates being pivotably supported with a common pivot support element disposed at the top rear corner of said knife handle with said pivot support providing means to open and close said cover plates through means provided for manual manipulation whereby said cover plates are formed to provide the exterior portion of said knife handle affected by the cut away providing access to said spare blades storage compartment with a smooth integrated exterior surface without interruption of surface continuity when said cover plates are in their closed positions,
e. means to selectively seize and extract a single blade from said plurality of spare blades from said spare blades storage compartment with said means carried by said top access cover plate.

2. A utility knife according to claim 1 wherein said cutting blade latching means has provided a small indentation on the top surface of said knife handle with said indentation exposing a portion of the rear of said pivotably supported latching element to permit exterior manual manipulation of said latching element to rotate said latching element against said spring element to disengage said downward extended blade engaging tab of said latching element with said rotation of latching element releasing retention of said cutting blade thereby permitting removal of said blade from said blade holding cavity thereby permitting installation of an unused cutting blade.

3. A utility knife according to claim 1 wherein said spare blades storage compartment is defined by a space whereby an inward side wall, a ceiling, a bearing floor, an obliquely angled forward partition, and an obliquely angled rear partition are provided by interior housing within the rear portion of said knife handle with said knife handle provided a cut away portion corresponding proportionately in shape to said spare blades storage compartment space defined in said knife handle with said cut away portion of said knife handle provided a peripheral wall adapted to the perimeter of said cut away portion to provide a blade retaining means affecting the outward plane of said storage compartment thereby providing an abuttment adjacent the bearing floor and the forward and rear partitions of said spare blades storage compartment whereby the outward vertical plane of the opening to said spare blades storage compartment is left unobstructed.

4. A utility knife according to claim 3 wherein said storage compartment in combination with said abutting retaining wall is disposed to hold a plurality of spare blades in a longitudinal direction vertically disposed to an inverted position whereby said blades are positioned with each base cutting edge of said blades disposed to an upward direction and the top margin edge is disposed to a downward direction to rest on said bearing floor of said storage compartment with said forward and rear obliquely angled partitions of said storage compartment providing an aligning means for said plurality of spare blades stored within said spare blades storage compartment.

5. A utility knife according to claim 3 wherein said spare blades storage compartment is provided a spring means comprising a spring element permanently attached to the center of said inward side wall in a laterally disposed position with said spring element supporting a floating plate disposed in a vertical and longitudinal position parallel to said side wall whereby said plate is urged by said spring element to apply an evenly distributed lateral pressure against said spare blade supply urging said blade supply toward said blade retaining wall abutting said spare blades storage compartment causing said blade supply to be captured between said spring actuated plate and said abutting blade retaining wall of said spare blades storage compartment.

6. A utility knife according to claim 1 wherein said access cover plates provided for said spare blades storage compartment are provided a common pivot support element whereby said cover plates are urged through spring means to remain in their respective closed or fully open positions whereas in their closed positions said side access cover plate is mated to said cut away which provides access to said spare blades storage compartment thereby permitting said side access cover plate to provide a smooth uninterrupted exterior surface integrating with the surface of said knife handle and said top access cover plate is mated to the top edge of said side access cover plate on one side and to the top edge of said spare blades storage compartment on the opposite side whereby said top access cover plate is supported on two sides to provide a smooth exterior surface integrated with the exterior top surface of said knife handle whereby said access cover plates combine to form a smooth exterior surface.

7. A utility knife according to claim 1 wherein said means for selectively seizing and extracting a spare blade from said spare blades storage compartment, with said means carried by said top access cover plate, is provided by clamping means permanently attached to the underneath side of closed said top access cover plate whereby said clamping means is formed of a vertically disposed straight first spring element having a sharply beveled end extending downward and a second spring element laterally opposed to and spaced from said first spring element whereby said second spring element is disposed to a downward biased direction toward said first spring element whereupon making contact with said first spring element is biased away from said first spring element thereby forming a configuration of laterally opposed spring elements combining to form a spring tensioned clip whereby said first spring element of said clip penetrates between the first and second blades of inverted said spare blades supply whereupon said second spring element, being biased toward and making contact with said first spring element of said blade clamping means, is separated and forced away from said first spring element as said clamping means has its two spring elements separated as the sharp edge of upturned said spare blade penetrates between said spring elements with said spring elements being forced apart and being of sufficient length and strength to seize said spare blade from said spare blade supply as said top access cover plate is rotated on said pivot support to said top access cover plate's open position.

8. A utility knife according to claim 1 wherein means provided for enclosing said spare blades compartment access opening comprises said side access cover plate and said top access cover plate whereas said top access cover plate is mated to the opening between the top edge of said side access cover plate and the top edge of said opening to said spare blades storage whereby opening said side access cover plate causes said top access cover plate to be carried to the open position also with both said cover plates rotating on a common pivot support element thus providing optimum available exposure of said access opening to said spare blades storage compartment to facilitate maintenance of said spare blades supply and further provides said top access cover plate to be opened independently of said side access cover plate whereby said spare blade extraction means attatched to the underneath side of the closed said top access cover plate is enabled to present an extracted spare blade with unobstructed accessibility.
